(19) United States
(12) Patent Application Publication
(10) Pub. No.: US 2013/0179445 A1
(43) Pub. Date: Jul. 11, 2013

(54) ELECTRONIC ORGANIZATION OF JOBSITE PHOTOGRAPHS

(71) Applicants: Robert J. Mathewson, Seattle, WA (US); Kieran W. Gaffey, Seattle, WA (US)

(72) Inventors: Robert J. Mathewson, Seattle, WA (US); Kieran W. Gaffey, Seattle, WA (US)

(21) Appl. No.: 13/734,138

(22) Filed: Jan. 4, 2013

Related U.S. Application Data
(60) Provisional application No. 61/583,471, filed on Jan. 5, 2012.

(51) Int. Cl. G06F 17/30

(52) U.S. Cl. CPC G06F 17/3028
USPC 707/736

(57) ABSTRACT

A method enables users to access critical information contained in construction photos.

### PRIORITY CLAIM

This application claims the benefit of priority to U.S. Provisional Application No. 61/583,471, filed Jan. 5, 2012, which is incorporated by reference as if fully set forth herein.

### BACKGROUND

A construction site is a dynamic environment where many disparate stakeholders come together for a short period to complete a project. While there are many resources available to these participants for managing their information, none of them addresses the complex environment of the jobsite. The most common tool for managing information on the jobsite is the digital photograph. While a picture is worth a thousand words, jobsite photos are an underutilized resource as there is no existing way to tag and catalog the vast amount of valuable information that can be found in a typical construction photo. As a result, construction operators suffer a lack of productivity due to their inability to leverage this powerful resource.

Jobsite photos are currently cataloged using internal systems relying on filename and folder organization. There are many text-based systems for tracking jobsite information offered by project management providers such as Prolog and Procor. Reports are typically compiled manually using word processing software such as Microsoft Word.

### DETAILED DESCRIPTION

An embodiment of the invention provides productivity tools to various stake holders involved in a construction project. By providing tools and processes for recording ongoing construction operations, an embodiment delivers critical, useful and timely information during construction and well after completion for any size project.

An embodiment of the invention may deliver a series of photo-driven productivity tools via a software-as-a-service web site. An embodiment of the invention includes a construction photo tool that provides an effective means to tag and search images and share those images in report format.

An embodiment of the invention includes an enterprise level tool for general contractors that provides added tools for centralizing jobsite resources (e.g., architectural details and material specifications) and trigger events on the jobsite (e.g., special inspections or new installations).

Naming Conventions and Definitions

General Contractors—aka GC, contractor, builder—the organization with primary responsibility for executing and managing construction operations. General contractors are hired by project owners (aka developers or real estate developers).

Building Consultant—This is a generic term for any number of specialty firms that focus on specific technical aspects of construction (e.g. waterproofing, acoustics, structural design and integrity, etc.) Building consultants are typically hired by the project's architect, but can also report to the owner.

Photos—aka images, pictures and pics generally refer to digital images recorded on a construction site by users using a digital camera.

Likely users may include those who shoot photos and prepare reports at jobsites, such as engineers and superintendents, and also report recipients who will view reports generated using a reporting tool according to an embodiment of the invention. Those interested in reports may include architects, bankers and insurers as well as construction managers.

Users may include general contractor executive management and project management plus the users of the reporting tool mentioned above.

Embodiments of the invention are operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

Embodiments of the invention may be referred to herein as, or in association with the term, Geedra.

In an embodiment of the invention, users can access critical information that's contained in construction photos. It all starts the moment a user connects a camera to the computer on which an embodiment is implemented. Geedra, running in the background, senses that new photos are available and allows you to choose which ones you will add to the user's Geedra photo database. As the user uploads photos to the Geedra website, the system automatically tags the photos with information the user previously entered in a user profile. Geedra uses trailer-ready technology to assign additional information to photos with little or no typing. Simply by dragging a photo onto a digital blueprint, an embodiment captures the grid location (i.e., coordinates) of the photo on the blueprint, the room number associated with such location, and the location type from a set of possible location types. This captured data may then be stored as metadata, for example, in association with the dragged photo. Such digital blueprints may be loaded (e.g., scanned in) by a user, or may be downloaded from a stored collection of digital blueprints. Users can specify the camera orientation for additional information that is helpful when researching photos. Details provided by the camera, including the date and time stamp, are available as well for storage as metadata, for example, in association with the dragged photo. Users can determine who has access to photos, and they can even use division codes to identify the work in the images. Finally, a comments section is available to add additional information as observed on the job site.

When it's time to use photos to research an issue, Geedra's interactive search allows for instant results so that the user can find what they're looking for within minutes. By entering and adjusting the search criteria in the fields on the right, the user can see the search results on the left appear instantly. No more searching through hundreds of file folders to find that exact photo. With Geedra, you can search through thousands of photos in minutes. Want to get a closer look at a photo? Move your mouse over it, roll the scroll wheel, and zoom right in on the details. When you find exactly what you're looking for, then use Geedra's dynamic graphical tagging to assign an icon right to the zone on the photo that interests you. This micro-tagging technique captures the exact position in the image that interests you and allows you to report it to your team members without any question about what it is you're talking about in the photo. Once your research is complete, you can use Geedra's automated report-builder to report the results to your project team. Geedra's data tags can also be seen in a list view that makes for easier sorting and searching of photos. Geedra distributes the reports from the distribution list that you enter, and the reports arrive by e-mail, complete with thumbnail photos and live links back into the Geedra system that will allow your project team members to view the photos using Geedra's tools, adding their comments, and creating a more complete project record. This capability will give your team the ability to follow issues from identification all the way through to resolution so they become a permanent part of your project's photo database that can be accessed during construction or years later.

Additional features according to one or more embodiments include the following:

DGT—Combining one visual element (subject matter) with another to provide context, whereby the associated physical gesture automatically creates a meta-tag with textual information that would otherwise require typing to create

Social Media Data Pooling

Increase searchable database by combining individual user photos into single database.

Increase searchable database by combining individual user photos into single database with a permission basis.

Social Media

Separating meta tags from their originating photos then combining into a master pool of meta tags that are available to other users for tagging new photos.

4. Permissions

Can be granted to individuals, groups of individuals, or groups of groups.

Permission criteria can include any combination of user ID, organization, project or any other group identifier, time, physical location, subject matter, area of responsibility, unique image or image group ID accessibility, transferability, editability.

5. Dragging photo to a location as indicated by a contextual visual element and automatically creating a textual data tag indicating the location of that photo relative to its position with the visual element and also entering that data tag into a database, perhaps as metadata in association with the dragged photo.

The drawing figures of this application include screenshots illustrating features and functionality of one or more embodiments of the invention and a chart indicating the types and functionality of icons that may be used to tag blueprints and/or photos.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method, comprising steps described above herein.
